(19) United States
(12) Patent Application Publication
(10) Pub. No.: US 2017/0275526 A1
(43) Pub. Date: Sep. 28, 2017

(54) SUPERCRITICAL Y-GRADE NGL

(71) Applicants: John A. BABCOCK, (US); Linde Aktiengesellschaft, Munich (DE)

(72) Inventors: John A. BABCOCK, Houston, TX (US); Charles P. SIESS, III, Conroe, TX (US); Naveed ASLAM, Houston, TX (US)

(21) Appl. No.: 15/400,321

(22) Filed: Jan. 6, 2017

Related U.S. Application Data
(60) Provisional application No. 62/311,830, filed on Mar. 22, 2016.

(51) Int. Cl. C09K 8/82; E21B 37/00; E21B 43/24; C11D 7/24; C11D 11/00

(52) U.S. Cl. CPC C09K 8/82; C11D 7/24; C11D 11/0029; C11D 11/0047; E21B 43/24; E21B 37/00; E21B 43/2405

(57) ABSTRACT

Use of supercritical Y-grade natural gas liquids for a variety of processes and across numerous industrial applications is described herein. The low viscosity, high density, and tunable solvent properties of supercritical Y-grade natural gas liquids are useful for example in enhanced reservoir recovery and treatment, control of chemical reactions and processes, and/or single or two-phase separations.

### CROSS-REFERENCE TO RELATED APPLICATION

This application claims priority to U.S. Provisional Application Ser. No. 62/311,830, filed Mar. 22, 2016, which is incorporated by reference herein in its entirety.

### BACKGROUND

Field

Embodiments of the disclosure relate to using an unfractionated hydrocarbon mixture, such as Y-Grade natural gas liquids, when in a supercritical state.

Description of the Related Art

A supercritical fluid (SCF) is any substance at a temperature and pressure above its critical point, where distinct liquid and gas phases do not exist. It can effuse through solids like a gas, and dissolve materials like a liquid. In addition, close to the critical point, small changes in pressure or temperature result in large changes in density, allowing many properties of a supercritical fluid to be “fine-tuned”. Frequently the term, compressed liquid, is used to indicate a supercritical fluid, a near-critical fluid, an expanded liquid or a highly compressed gas.

A SCF has densities similar to that of liquids, while the viscosities and diffusivities are closer to that of gases. Thus, a SCF can diffuse faster in a solid matrix than a liquid, yet possess a solvent strength to extract the solute from the solid matrix. SCF's also have unique solution properties stemming from their behavior near the critical point. It is frequently observed that SCF's exhibit a “retrograde” behavior near their critical point where an increase in temperature of the solvent SCF increases solubility of a solute in some pressure ranges while decreasing it in other pressure ranges.

Chemical and petrochemical processing relies heavily on use of solvents and solutions, and there is always a need for versatile hydrocarbon-based solvents in the chemical and petrochemical industries.

### SUMMARY

A method of using a supercritical fluid comprises providing an unfractionated hydrocarbon mixture, and maintaining the unfractionated hydrocarbon mixture at a pressure and a temperature above a critical point such that the unfractionated hydrocarbon mixture is in a supercritical state where distinct liquid and gas phases do not exist.

### BRIEF DESCRIPTION OF THE DRAWINGS

FIG. 1 is a phase diagram of a Y-Grade NGL mixture, according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments of the disclosure include the use of an unfractionated hydrocarbon based mixture in a supercritical state across a variety of industrial applications.

Y-Grade NGL is an un-fractionated hydrocarbon mixture comprising ethane, propane, butane, isobutane, and pentane plus. Pentane plus comprises pentane, isopentane, and/or heavier weight hydrocarbons, for example hydrocarbon compounds containing at least one of C5 through C8+. Pentane plus may include natural gasoline for example.

Typically, Y-Grade NGL is a by-product of de-methanized hydrocarbon streams that are produced from shale wells and transported to a centralized facility. Y-Grade NGL can be locally sourced from a splitter facility, a gas plant, and/or a refinery and transported by truck or pipeline to a point of use. In its un-fractionated or natural state (under certain pressures and temperatures, for example within a range of 250-600 psig and at wellhead or ambient temperature), Y-Grade NGL has no dedicated market or known use. Y-Grade NGL must undergo processing before its true value is proven.

The Y-Grade NGL composition can be customized for handling as a liquid under various conditions. Since the ethane content of Y-Grade NGL affects the vapor pressure, the ethane content can be adjusted as necessary. According to one example, Y-Grade NGL may be processed to have a low ethane content, such as an ethane content within a range of 3-12 percent, to allow the Y-Grade NGL to be transported as a liquid in low pressure storage vessels. According to another example, Y-Grade NGL may be processed to have a high ethane content, such as an ethane content within a range of 38-60 percent, to allow the Y-Grade NGL to be transported as a liquid in high pressure pipelines.

Y-Grade NGL differs from liquefied petroleum gas (“LPG”). One difference is that LPG is a fractionated product comprised of primarily propane, or a mixture of fractionated products comprised of propane and butane. Another difference is that LPG is a fractioned hydrocarbon mixture, whereas Y-Grade NGL is an unfractionated hydrocarbon mixture. Another difference is that LPG is produced in a fractionation facility via a fractionation train, whereas Y-Grade NGL can be obtained from a splitter facility, a gas plant, and/or a refinery. A further difference is that LPG is a pure product with the exact same composition, whereas Y-Grade NGL can have a variable composition.

In its unfractionated state, Y-Grade NGL is not an NGL purity product and is not a mixture formed by combining one or more NGL purity products. An NGL purity product is defined as an NGL stream having at least 90% of one type of carbon molecule. The five recognized NGL purity products are ethane (C2), propane (C3), normal butane (NC4), isobutane (IC4) and natural gasoline (C5+). The unfractionated hydrocarbon mixture must be sent to a fractionation facility, where it is cryogenically cooled and passed through a fractionation train that consists of a series of distillation towers, referred to as deethanizers, depropanizers, and debutanizers, to fractionate out NGL purity products from the unfractionated hydrocarbon mixture. Each distillation tower generates an NGL purity product. Liquefied petroleum gas is an NGL purity product comprising only propane, or a mixture of two or more NGL purity products, such as propane and butane. Liquefied petroleum gas is therefore a fractionated hydrocarbon or a fractionated hydrocarbon mixture.

In one embodiment, Y-Grade NGL comprises 30-80%, such as 40-60%, for example 43%, ethane, 15-45%, such as 20-35%, for example 27%, propane, 5-10%, for example 7%, normal butane, 5-40%, such as 10-25%, for example 10%, isobutane, and 5-25%, such as 10-20%, for example 13%, pentane plus. Methane is typically less than 1%, such as less than 0.5% by liquid volume.

In one embodiment, Y-Grade NGL comprises dehydrated, desulfurized wellhead gas condensed components that have a vapor pressure of not more than about 600 psig at 100 degrees Fahrenheit (° F.), with aromatics below about 1 weight percent, and olefins below about 1% by liquid volume. Materials and streams useful for the embodiments described herein typically include hydrocarbons with melting points below about 0 degrees Fahrenheit (° F.).

Y-Grade NGL is typically created in a local natural gas processing plant or splitter facilities as a byproduct of condensing a “wet gas” stream. This is typically accomplished by first dehydrating the wet gas stream to remove entrapped water and then cooling the stream, reducing the temperature below the hydrocarbon dew point temperature and condensing a portion of the raw natural gas into Y-Grade natural gas liquids.

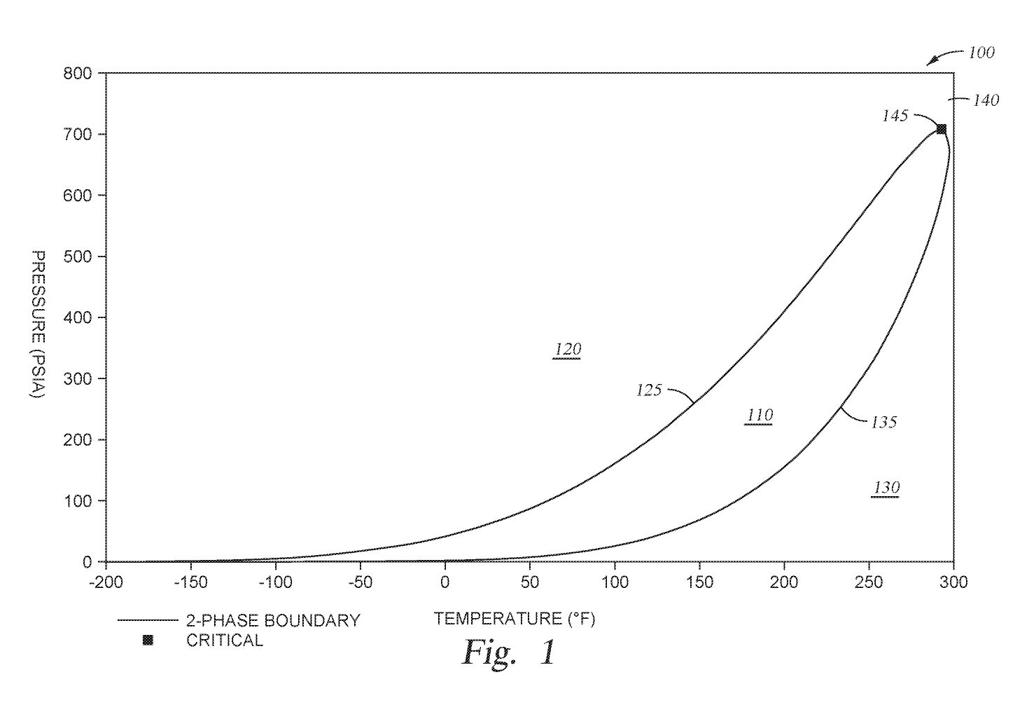

FIG. 1 is a phase diagram 100 for a mixture of Y-Grade NGL, according to one embodiment. The mixture of Y-Grade NGL comprises about 12.2% ethane, about 37.8% propane, about 34.2% butane, about 8.4% pentane, about 4.9% hexane, about 1.6% heptane, and about 0.9% octane. The phase diagram 100 illustrates a two-phase region 110 where both gas and liquid exists, a liquid region 120, and a gas region 130.

The bubble point curve, e.g. the point at which a gas-phase first appears, is shown by boundary line 125. The dew point curve, e.g. the point at which a liquid-phase first appears, is shown by boundary line 135. The critical point, e.g. the point at a temperature and a pressure beyond which liquid and gas no longer exist as separate phases, is shown by critical point 145. The critical point 145 is at a pressure about 700 psia and at a temperature about 280° F. The area where the Y-Grade NGL mixture exists as a supercritical fluid, e.g. is in a supercritical state, is in supercritical region 140 which is at a temperature and a pressure above the critical point 145.

According to the phase diagram 100, the Y-Grade NGL mixture is in a supercritical state when at a pressure above about 700 pounds per square inch (psia), for example about 705-710 psia, and at a temperature above about 280° F., for example about 285-290° F. Y-Grade NGL when in a supercritical state acts as a supercritical fluid that can be used across a broad range of industrial applications.

In one embodiment, Y-Grade NGL when in a supercritical state (also referred to herein as “supercritical Y-Grade NGL”) may be used to improve recovery in a conventional resource reservoir. The supercritical Y-Grade NGL is injected at the surface in a pattern that ensures proper sweep at sufficient pressure to maintain the supercritical state of the Y-Grade NGL. The injection of the supercritical Y-Grade NGL is usually accomplished in pulses lasting several weeks or months, and may be alternated with the injection of water pulses for similar periods of time.

The low surface tension, higher density, solubility and miscibility of the supercritical Y-Grade NGL aid in mobilizing residual hydrocarbons which were unrecoverable under primary and secondary recovery technologies. The low surface tension reduces capillary forces that retain bound hydrocarbons, the high density allows for a more favorable mobility ratio, and the solubility and miscibility properties of the supercritical Y-Grade NGL may be used to enhance the extraction and displacement of hydrocarbons from the reservoir.

The supercritical Y-Grade NGL may be maintained in supercritical state by maintaining a reservoir pressure near the critical pressure of Y-Grade NGL, for example above about 700 psia. The supercritical Y-Grade NGL may be maintained in supercritical state by maintaining a reservoir temperature above the critical temperature of Y-Grade NGL, for example above about 280° F.

In one embodiment, supercritical Y-Grade NGL may be used as a carrier and displacement fluid to transport chemical compositions for cleaning wellbore and near-wellbore areas from damage related to drilling, workover operations, and degradation of the near wellbore and subsurface formation, especially in low pressure formations. The properties of the supercritical Y-Grade NGL allow an operator to precisely control the location of the reservoir treatment chemical. The low surface tension, solvent and non-damaging characteristics of supercritical Y-Grade NGL make it an ideal carrier fluid for remedial wellbore and subterranean reservoir treatments. One or more treatment chemicals are mixed with the supercritical Y-Grade NGL and then injected into the formation. Such processes may be used to remediate damage to the formation.

Unconventional and conventional subterranean reservoirs often times require hydraulic fracture stimulation treatment to establish economically recoverable rates of hydrocarbon production and reserves. A typical fracture treatment injects a viscous frac fluid to open a fracture of a desired geometry, and the viscous frac fluid carries a proppant into the opened fracture to maintain conductivity in the fracture after the treatment is completed. Aqueous frac fluids have inherent properties that damage the permeability of the proppant pack and/or the subterranean reservoir. Non-aqueous fluids in a supercritical state, such as supercritical Y-Grade NGL, are non-damaging to the formation, have minimal chemical additions, are naturally occurring have locally available components, have fast clean-up, are cost effective, and are totally recoverable with minimal proppant flow back.

Supercritical Y-Grade NGL can be used as a hydraulic fracturing fluid if the pressure is maintained above the yield strength of the formation. The higher density and lower surface tension of supercritical Y-Grade NGL reduces the hydraulic pressure required to fracture the reservoir. The higher density of the supercritical Y-Grade NGL also increases the proppant load carrying capacity which in turn reduces the overall fluid volume.

Supercritical extraction has been applied to a large number of solid matrices. The desired product can be either the extract or the extracted solid itself. The advantage of using supercritical Y-Grade NGL in extraction is the ease of separation of the extracted solute from the supercritical fluid by simple expansion. In addition, supercritical Y-Grade NGL has liquid like densities but superior mass transfer characteristics compared to liquid solvents due to high diffusion and very low surface tension that enables easy penetration into the porous structure of the solid matrix to release the solute.

Extraction of polymers can be done using supercritical Y-Grade NGL. Polymers can uptake a significant amount of the supercritical Y-Grade NGL. As the concentration of the compressed fluid is increased in the polymer phase, the sorption and subsequent swelling of an amorphous polymer can cause a glass-to-liquid-phase transition. The glass transition temperature of the polymer may be drastically reduced and this behavior may be exploited in polymer processing to produce extremely small voids only a few micrometers in diameter.

Enzymatic reactions in non-aqueous media, especially supercritical fluids, are gaining acceptance. The density of supercritical Y-Grade NGL is comparable to that of liquids, while the viscosities and diffusion coefficients are comparable to that of gases. This enhances the rates for diffusion controlled reactions. Supercritical Y-Grade NGL has application to enzymatic reactions.

The ability to design surfactants for the interface between water and supercritical Y-Grade NGL offers new avenues in protein and polymer chemistry, separation science, reaction engineering, waste minimization and treatment. Surfactant design is well understood for conventional reverse micelles and water-in-oil microemulsions for alkane solvents.

Fractionation is difficult to achieve in distillation because the impurities have about the same volatility as the primary components reducing the overall selectivity. Supercritical Y-Grade NGL can be used to fractionate low vapor pressure oils and polymers. The low vapor pressure material or polymer is exposed to the supercritical Y-Grade NGL prior to the fractionation to form a material mixture in which the supercritical Y-Grade NGL can dissolve the material. The material mixture is maintained in supercritical state during the dissolving process by maintaining temperature and/or pressure near the critical point 145 of the Y-Grade NGL. The material mixture is then fractionated by applying a differential temperature, pressure, or both (e.g. adjusting at least one of pressure and temperature) to the supercritical Y-Grade NGL.

Supercritical Y-Grade NGL is an attractive media for several chemical reactions. By small adjustments in pressure, the reaction rate constants can be altered by two orders of magnitude. Equilibrium constants for reversible reactions can also be changed 2-6 fold by small changes in pressure. This dramatic control over the reaction rates has led to the design of several reactions in different areas of biochemistry, polymer chemistry and environmental science. Supercritical Y-Grade NGL can be used for adjusting the rate of reaction in several chemical reactions.

Supercritical Y-Grade NGL can be used extensively in the material and polymer industry. Rapid expansion from supercritical solutions across an orifice or nozzle is used commercially to precipitate solids. In this technique, a solute dissolved in supercritical Y-Grade NGL is depressurized rapidly. By controlling the operating variables carefully, the desired precipitated morphology can be attained.

Solubilities and recrystallization of various drugs has been demonstrated in supercritical fluids. Since the residual solvent present in the extracted material is of critical importance in the pharmaceutical industry, supercritical Y-Grade NGL can be found to have several applications.

The use of supercritical Y-Grade NGL as an anti-solvent while modifying operating parameters, nozzle shapes and material properties can generate engineered structures such as nano-spheres, empty balloons, microfibers, microencapsulation and supercritical suspensions.

The use of supercritical Y-Grade NGL as a high diffusivity solvent is the basis of supercritical impregnation. The supercritical Y-Grade NGL is a powerful solvent that can impregnate even in the smallest pores of the matrix (when porous).

Supercritical Y-Grade NGL provides a type of solvent for conducting reactions. Supercritical Y-Grade NGL is a tunable solvent whereby the density, reaction rate, yield, and selectivity can be controlled.

Supercritical Y-Grade NGL can be used in numerous industrial applications including fractionation, byproduct extraction, surfactant purification, manufacturing of foams and aerogels, anti-solvent for nano-particles, petrochemical suspensions, micro-encapsulation fluid, impregnation fluid, tunable solvent, and recrystallization of pharmaceuticals fluid.

In one embodiment, a method of hydraulic fracturing a conventional or unconventional hydrocarbon bearing reservoir comprises injecting a supercritical Y-Grade NGL fracturing fluid into a hydrocarbon bearing reservoir at a pressure above the yield strength of the reservoir to fracture the reservoir. The supercritical Y-Grade NGL fracturing fluid can initiate and maintain fracture growth and have a sufficient viscosity to transport proppant mixed with the supercritical Y-Grade NGL fracturing fluid into the reservoir.

In one embodiment, a method of enhanced hydrocarbon recovery comprises providing supercritical Y-Grade NGL to a conventional reservoir; and mobilizing and displacing hydrocarbons from the reservoir using the supercritical Y-Grade NGL.

In one embodiment, a method of improving conductivity of a hydrocarbon reservoir comprises forming a mixture of a supercritical Y-Grade NGL and one or more reservoir treatment chemicals; and transporting the mixture to a wellbore area of the hydrocarbon reservoir.

In one embodiment, a method of separating a low vapor pressure material comprises forming a mixture of the low vapor pressure material with supercritical Y-Grade NGL; and fractionating the mixture by a process that includes differential temperature, differential pressure, or both.

In one embodiment, a method of performing a chemical reaction comprises forming a mixture of one or more reactants in supercritical Y-Grade NGL; maintaining the supercritical state of the supercritical Y-Grade NGL while performing a chemical reaction with one of the one or more reactants; and adjusting the supercritical properties of the supercritical Y-Grade NGL by adjusting the temperature, pressure, or both, of the supercritical Y-Grade NGL.

In one embodiment, a solid-liquid separation method comprises exposing a solid having an absorbed liquid to supercritical Y-Grade NGL; and separating at least a portion of the absorbed liquid from the solid using the supercritical Y-Grade NGL as a solvent.

In one embodiment, a method of forming voids in a polymer matrix comprises contacting the polymer matrix with supercritical Y-Grade NGL; intercalating the supercritical Y-Grade NGL into the polymer matrix; and vaporizing the supercritical Y-Grade NGL to form a void in the polymer matrix.

In one embodiment, a method of performing an enzymatic reaction comprises forming a mixture of an enzyme and a target in supercritical Y-Grade NGL; and controlling diffusion of the enzyme and the target in the mixture by adjusting the temperature, pressure, or both, of the supercritical Y-Grade NGL.

In one embodiment, a method of performing a liquid interface process comprises disposing a liquid having a surface in a container; applying a layer of supercritical Y-Grade NGL to the surface of the liquid; and performing a liquid interface process while maintaining the supercritical Y-Grade NGL in a supercritical state.

In one embodiment, supercritical Y-Grade NGL may be used to modify equilibrium constants for reversible reactions in areas of biochemistry, polymer chemistry and environmental science; commercially precipitate solids into desired morphologies; recrystallize various drugs found in the pharmaceutical industry; as an anti-solvent to generate engineered structures such as nano-spheres, empty balloons, microfibers, microencapsulation and supercritical suspensions; as a solvent to impregnate the smallest pores of a solid matrix (when porous); to generate foams and aerogels; for gas an liquid chromatography; for heterogenous and homogeneous catalytic reactions; for chemical synthesis; for reactive deposition; for continuous hydrogenation of organic compounds, for extraction of metals; and for inorganic and metal-organic co-cordination chemistry.

In one embodiment, an unfractionated hydrocarbon mixture, such as Y-Grade NGL, in a supercritical state can be used for and in the following processes and industrial applications:

Extraction from solid materials, which could include polymer stripping;

Fractionation of difficult to extract aeromatics, polymers, and poly unsaturated fatty acids;

Reactions in large scale petrochemical plants, for instance butene hydration to 2-butenal, and in fine chemistry, for instance highly selective synthesis;

With paints and coatings, including powder coatings for suspension of polymers and pigments, and to reduce paint viscosity;

In polymer processing, such as to generate plasticyzers, impregnation, extraction of residues, morphology modifications, and blending alloys;

In ceramics, such as ceramic binder extraction;

In foams and aerogels, such as polymeric foams, microcellular foams, and thermoplastics, and for drying of aerogels and cylical aerogels using Y-Grade NGL;

In particle design, manufacturing particles using the rapid expansion of supercritical Y-Grade NGL, and for engineered structures, including nanospheres, empty ballons, and hollow microfibers;

In Impregnation, such as a tunable solvent, to impregnate matrix porosity, and dyeing of synthetic fibers;

In cleaning, such as degreasing of mechanical and/or electrical parts; and

In reaction media, such as enzymatic reactions and oxidation, density or co-solvent tunings of reaction rates and yields, improved mass transfer, and simultaneous separation with reaction.

While the foregoing is directed to certain embodiments, other and further embodiments may be devised without departing from the basic scope of this disclosure.

We claim:

1. A method of using a supercritical fluid, comprising:
providing an unfractionated hydrocarbon mixture; and
maintaining the unfractionated hydrocarbon mixture at a pressure and a temperature above a critical point such that the unfractionated hydrocarbon mixture is in a supercritical state where distinct liquid and gas phases do not exist.

2. The method of claim 1, wherein the critical point is at a pressure about 700 psia and at a temperature about 280° F.

3. The method of claim 2, wherein the unfractionated hydrocarbon mixture comprises about 12.2% ethane, about 37.8% propane, about 34.2% butane, about 8.4% pentane, about 4.9% hexane, about 1.6% heptane, and about 0.9% octane.

4. The method of claim 1, further comprising mixing the unfractionated hydrocarbon mixture when in the supercritical state with a reservoir treatment chemical.

5. The method of claim 1, further comprising mixing the unfractionated hydrocarbon mixture when in the supercritical state with a proppant, and injecting the unfractionated hydrocarbon mixture when in the supercritical state with the proppant into a hydrocarbon bearing reservoir at a pressure above a yield strength of the hydrocarbon bearing reservoir to fracture the hydrocarbon bearing reservoir.

6. The method of claim 1, further comprising injecting the unfractionated hydrocarbon mixture when in the supercritical state into a hydrocarbon bearing reservoir, and mobilizing and displacing hydrocarbons from the hydrocarbon bearing reservoir using the unfractionated hydrocarbon mixture when in the supercritical state.

7. The method of claim 1, further comprising mixing the unfractionated hydrocarbon mixture when in the supercritical state with a low vapor pressure material to form a material mixture, and fractionating the material mixture by adjusting at least one of pressure and temperature.

8. The method of claim 1, further comprising mixing the unfractionated hydrocarbon mixture when in the supercritical state with one or more reactants to form a reactant mixture, and performing a chemical reaction with one of the one or more reactants while maintaining the unfractionated hydrocarbon mixture in the supercritical state.

9. The method of claim 1, further comprising mixing the unfractionated hydrocarbon mixture when in the supercritical state with a solid having an absorbed liquid, and separating at least a portion of the absorbed liquid from the solid by using the unfractionated hydrocarbon mixture when in the supercritical state as a solvent.

10. The method of claim 1, further comprising contacting the unfractionated hydrocarbon mixture when in the supercritical state with a polymer matrix, intercalating the unfractionated hydrocarbon mixture when in the supercritical state into the polymer matrix, and vaporizing the unfractionated hydrocarbon mixture to form a void in the polymer matrix.

11. The method of claim 1, further comprising mixing the unfractionated hydrocarbon mixture when in the supercritical state with an enzyme and a target, and controlling diffusion of the enzyme and the target using the unfractionated hydrocarbon mixture when in the supercritical state.

12. The method of claim 1, further comprising applying a layer of the unfractionated hydrocarbon mixture when in the supercritical state onto a surface of a liquid in a container, and preforming a liquid interface process using the unfractionated hydrocarbon mixture when in the supercritical state.

13. The method of claim 1, further comprising drying an aerogel using the unfractionated hydrocarbon mixture when in the supercritical state.

14. The method of claim 1, further comprising manufacturing particles using the unfractionated hydrocarbon mixture when in the supercritical state.

15. The method of claim 1, further comprising impregnating a porous matrix using the unfractionated hydrocarbon mixture when in the supercritical state.

16. The method of claim 1, further comprising degreasing mechanical or electrical parts using the unfractionated hydrocarbon mixture when in the supercritical state.
